(19) United States
(12) Patent Application Publication
(10) Pub. No.: US 2002/0154221 A1
(43) Pub. Date: Oct. 24, 2002

(54) Digital camera, digital photographic system, and image transmission method using the digital photographic system

(76) Inventor: Toshiaki Ishimaru, Hino-shi (JP)

Correspondence Address: STRAUB & POKOTYLO, 1 BETHANY ROAD, SUITE 83, BUILDING 6, HAZLET, NJ, 07730, US

(21) Appl. No.: 10/131,757

(22) Filed: Apr. 23, 2002

(30) Foreign Application Priority Data
Apr. 24, 2001 (JP) 2001-126356

(51) Int. Cl. H04N 5/225

(52) U.S. Cl. 348/207.1

(57) ABSTRACT

A digital camera is characterized by displaying an alarm in a display device in its finder, in the case where it cannot communicate with receivable equipment located nearby, or there is no receivable equipment located nearby.

### CROSS-REFERENCE TO RELATED APPLICATIONS

This application is based upon and claims the benefit of priority from the prior Japanese Patent Application No. 2001-126356, filed Apr. 24, 2001, the entire contents of which are incorporated herein by reference.

### BACKGROUND OF THE INVENTION

1. Field of the Invention

The present invention relates to, for example, a camera including means for communication, in particular, a digital camera capable of storing recorded image on a network and a digital photographic system.

2. Description of the Related Art

In the Jpn. Pat. Appln. KOKAI Publication No. 2000-278570, there has been disclosed that a part of video signals acquired by photographing is taken in as a still image and transmitted through a telephone line. In Jpn. UM Appln. KOKAI Publication No. 63-187132, there has been disclosed that alarm indication is performed in a finder when an interchangeable lens including no interchangeable lens information is mounted.

In the Jpn. Pat. Appln. KOKAI Publication No. 2000-278570 mentioned above, disclosed is a method of transmitting image data while confirming video photographed and recorded by a camera recorder through a view finder or an external display of the camera recorder. In the method, image displaying means which is used for confirming the photographed image by the camera recorder itself, is required. Using an image display device in the finder leads to increase in costs of the camera in comparison with a camera using an optical finder. In a camera in which an image display must be confirmed through an external image display device, two operations, i.e., photographing by looking through a finder and then confirming transmission through the external image displaying device, are required, which is inconvenient.

### BRIEF SUMMARY OF THE INVENTION

An object of the present invention is to provide a digital camera capable of confirming whether image data has been transmitted properly in an optical finder while suppressing increase in costs, a digital photographic system and an image transmission method using the digital photographic system.

A digital camera according to an aspect of the invention, comprises:

a release section to perform a shutter operation;

a finder section to observe an object;

a short-range radio communication section to perform radio communication with a radio communication terminal within a short range; and

a first alarm section to alarm in a case where radio communication with the radio communication terminal cannot be carried out with use of the short-range radio communication section, and transmitting image data photographed in accordance with an operation of the release section with use of the short-range radio communication section to the radio communication terminal.

A digital photographic system according to an aspect of the invention, comprises:

a digital camera having a release section to perform a shutter operation, a first short-range radio communication section which performs radio communication and photographing image data in corresponding with an operation of the release section;

a radio communication terminal having a second short-range radio communication section which performs radio communication a mobile phone communication section which performs radio communication, a position information detecting section which detects a current position and an image displaying section which receives the image data transmitted from the digital camera and displays the received image data; and

a data base on the Internet, which receives the image data transmitted from the radio communication terminal and stores the received image data.

An image transmission method using the digital photographic system, according to an aspect of the invention, is a method using a digital photographic system that comprises a radio communication terminal having a radio communication section, a short-range radio communication section, a release section, a displaying section and a digital camera,

wherein the digital camera photographs an object in correspondence with an operation of the release section and generates image data concerning the object,

the digital camera transmits the image data to the radio communication terminal with use of the short-range radio communication section,

the radio communication terminal transmits the image data to a data base on the Internet with use of the radio communication section, and

the method using a digital photographic system which indicates a state of radio communication at the time of generating the image data or transmitting the image data in the displaying section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiment of the invention, and together with the general description given above and the detailed description of the embodiment given below, serve to explain the principles of the invention.

FIG. 1 is a block diagram for explaining an outline of a digital photographic system according to an embodiment of the present invention;

FIG. 2 is a perspective view for explaining an appearance of a digital camera according to an embodiment of the invention;

FIG. 3 is a perspective view of a mobile phone associated with a digital photographic system according to an embodiment of the invention;

FIG. 4A is a block diagram showing an internal structure of a digital camera according to an embodiment of the invention;

FIG. 4B is a block diagram showing an internal structure of a mobile phone associated with a digital photographic system according to an embodiment of the invention;

FIG. 5 is a block diagram showing respective protocol structures of a digital camera, mobile phone, mobile phone base station and digital camera, each of which associated with a digital photographic system according to an embodiment of the invention;

FIG. 6 is a diagram showing a mutual communication process between a digital camera, mobile phone, mobile phone base station and digital camera associated with a digital photographic system according to an embodiment of the invention;

FIG. 7 is a diagram showing a flow from a processing of adding various data to image data photographed by a digital camera to a processing of storing the image data in a data base in a digital photographic system according to an embodiment of the invention;

FIG. 8 is a diagram showing a structure of data which are stored in a data base of a digital photographic system according to an embodiment of the invention;

FIG. 9 is a diagram showing a state of displaying a map in an operation of downloading an image from a data base through a mobile phone in a digital photographic system according to an embodiment of the invention;

FIG. 10 is a diagram showing a state of displaying a map of a specific area in an enlarged manner in an operation of downloading an image from a data base through a mobile phone in a digital photographic system according to an embodiment of the invention;

FIG. 11 is a diagram showing a state of displaying a list of image data classified into AM (before noon) and PM (afternoon) of a date when downloading an image from a data base through a mobile phone in a digital photographic system according to an embodiment of the invention;

FIG. 12 is a diagram showing a state of displaying image data when downloading an image from a data base through a mobile phone in a digital photographic system according to an embodiment of the invention;

FIG. 13 is a diagram showing a procedure for downloading an initial screen of a mobile phone in a digital photographic system according to an embodiment of the invention;

FIG. 14 is a diagram showing a procedure for setting a screen of FIG. 10 in a mobile phone in a digital photographic system according to an embodiment of the invention;

FIG. 15 is a diagram showing a procedure for setting a screen of FIG. 11 in a mobile phone in a digital photographic system according to an embodiment of the invention;

FIG. 16 is a diagram showing a procedure for setting a screen of FIG. 12 in a mobile phone in a digital photographic system according to an embodiment of the invention;

FIG. 17 is a diagram showing a procedure for switching display image data in a mobile phone in a digital photographic system according to an embodiment of the invention; and

FIG. 18 is a diagram showing a procedure for enlarging display image data in a mobile phone in a digital photographic system according to an embodiment of the invention.

### DETAILED DESCRIPTION OF THE INVENTION

An embodiment of the invention now will be described in detail below with reference to the accompanied drawings.

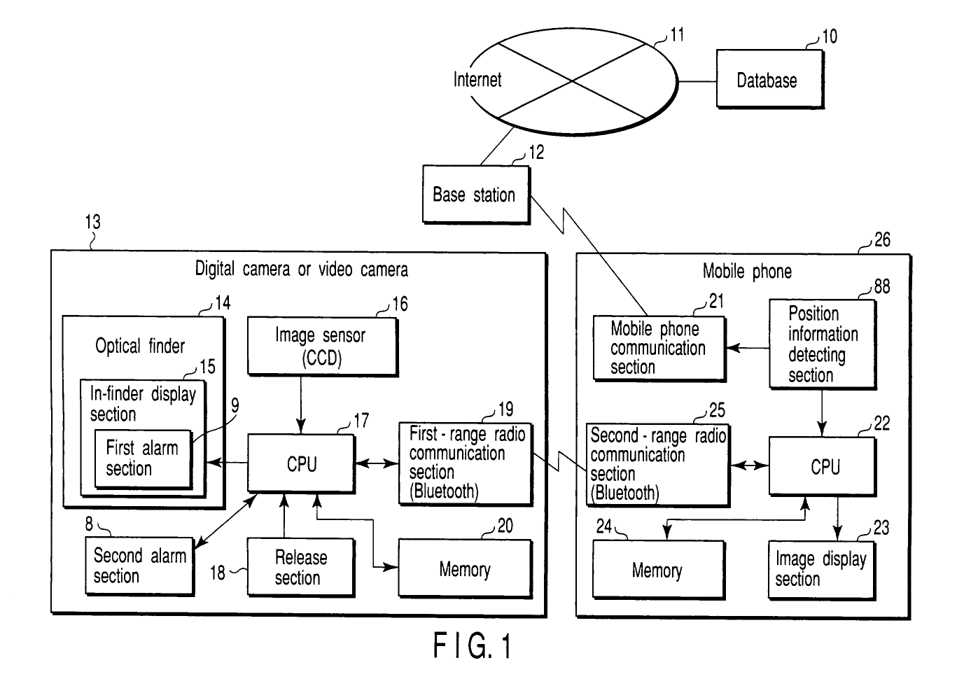

As shown in FIG. 1, a digital camera 13 comprises: a photographic device constituted by a photographic optical system, CCD (Charge Coup Led Device), and an image sensor 16 such as a CMOS (Complementary Metal-Oxide Semiconductor) or the like; an optical finder 14 to focus an object; an in-finder display section 15; a first alarm section 9 disposed in the in-finder display section 15; and a release section 18 such as a release switch, remote control device or the like. The digital camera 13 further comprises: a short-range radio communication section 19 such as Bluetooth (TM) or the like; a control section 17 constituted by a CPU (Central Processing Unit) or the like; a second alarm section 8 connected to the control section 17; and a memory 20.

Incidentally, when either the first alarm section 9 or second alarm section 8 alarms, it is possible that the control section 17 locks the release section 18 so as not to perform a release operation.

A mobile information terminal that is a radio communication terminal uses a communication apparatus such as a mobile phone 26, for example. The mobile phone 26 includes: a mobile phone communication section 21; a short-range radio communication section 25 such as Bluetooth (TM) or the like; a memory 24; a position information detecting section 88 constituted by a GPS or the like; a control section 22; and an image display section 23.

A user of the digital camera 13 determines an object by looking the object through the optical finder 14. Thereafter, the release section 18 performs releasing, and the object is photographed through the image sensor 16. Then, the object is stored in the memory 20 as image data. The photographed image data are transmitted from the digital camera 13 to the mobile phone 26 through the short-range radio communication section 19. In the mobile phone 26, the image data mentioned above are received through the short-range radio communication section 25 and stored in the memory 24. Thus, the user can read the image data mentioned above from the memory 24 and arbitrarily display the same on the image display section 23.

At the same time, the photographed image data are transmitted by the mobile phone communication section 21 to a data base 10 on the Internet 11 via a base station 12, and stored therein. Since the photographed image data mentioned above are displayed on the image display section 23 in the mobile phone 26, it is not necessary for the digital camera 13 to have an image display section, which makes it possible to reduce the size of the camera and its cost.

The data base 10 on the Internet 11 can use, for example, a storage device such as a HDD or the like on a server. That facilitates the data base to have vast amounts of capacity, i.e., the amount of several tera bytes or more. Therefore, the photographed image data are not limited by a capacity of the memory 24 in the mobile phone 26. Thus, photographing can be substantially performed with no limit.

However, since image data are transmitted by radio communication of the short-range radio communication section 25 and the mobile phone communication 21, sometimes communication cannot be carried out due to turning off of a power supply of the mobile phone 26, and sometimes communication between the mobile phone 26 and the base station 12 cannot be carried out inside buildings where a radio wave is out of the valid range. In these cases, it is not possible to photograph more than the capacity of the memories 20 and 24, thereby the number of photographing is limited. Therefore, the capacity of the memories is consumed by photographing inadvertently so that a necessary scene may fail to be photographed. However, since a communication state between the digital camera 13 and the mobile phone 26, or between the mobile phone 26 and the base station 12 is displayed on the in-finder display section 15, the user can grasp the status of the communication state even the user concentrates on the object. Accordingly, the digital camera 13 can cause the user to photograph carefully with consideration of residual capacity in the memory 20.

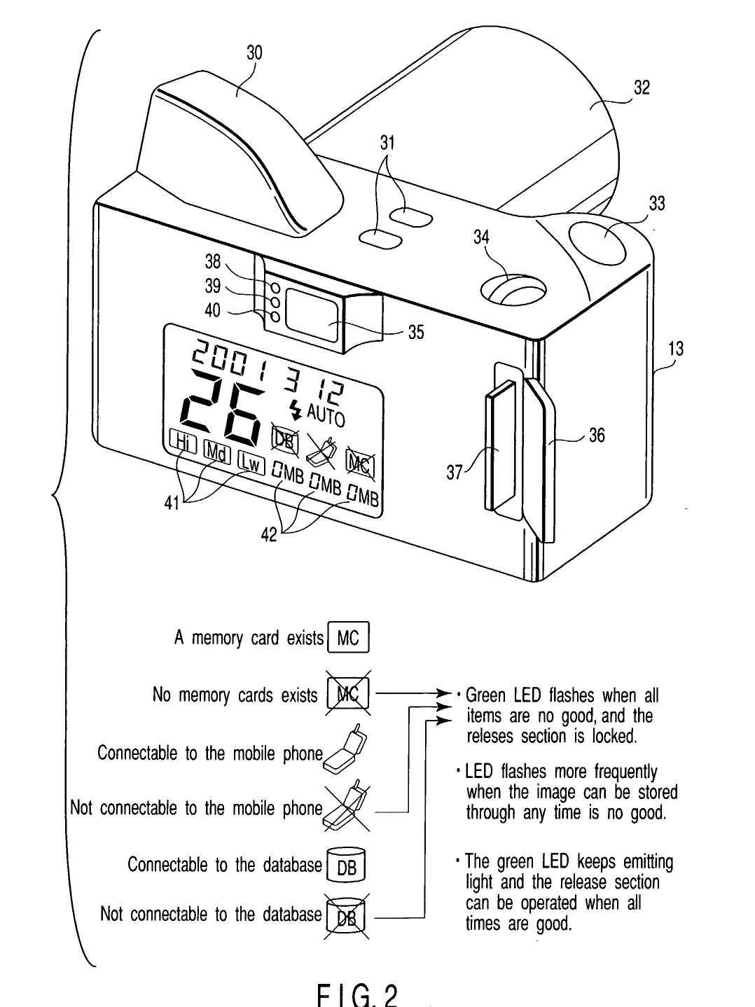

Next, a digital camera according to an embodiment of the invention will be described in detail with reference to FIG. 2. The digital camera 13 that is a zoom camera including an electronic flash is provided with a zoom switch 34, a release switch 33, a mode switch 31 and a strobe light emitting section 30, those being disposed on the upper surface of the camera. Further, a finder window 35 is disposed on the back face of the camera. Next to the finder window 35, three LEDs (Light Emitting Diodes) and a LCD (Liquid Crystal Display) are disposed.

The three LEDs are composed of green LED 38, orange LED 39 and blue LED 40, which are arranged in this order from the top to down. The green LED 38 is used for focus indication. That is, the green LED 38 lights when coming into focus, and flashes when being out of focus so as to represent that releasing is forbidden. The orange LED 39 is used for strobe light emitting indication. That is, the orange LED 39 lights when the electronic flash can emit, and flashes when the electronic flash cannot emit due to uncharging even in the case where the emission is necessary so as to represent that releasing is forbidden. The blue LED 40 is used for indication of a communication state. The blue LED 40 lights when communication is established and image data can be stored in a data base. When the communication cannot be established between a digital camera and a mobile phone, or between a mobile phone and a data base, but when image data can be stored in a memory within the digital camera or a memory of the mobile phone, the blue LED 40 flashes in a short cycle of about 8 Hz so as to give an alarm but permits photographing (alternatively, photographing may be forbidden arbitrarily.). Further, when communication cannot be carried out and memories are fully used, the blue LED 40 flashes in a long cycle of about 2 Hz so as to represent that releasing is forbidden.

In the LCD mentioned above, three icons (pictorial display) 42, each corresponding to a memory card, mobile phone and data base, are displayed. With respect to these three icons, when the icon “MC” is properly displayed in the LCD, the fact represents that the memory card exists. When the icons of the mobile phone and data base (DB) are properly displayed, the fact represents that the digital camera 13 is in the possible state of communicating with the mobile phone or data base properly.

On the other hand, when a mark X is added to the icon “MC”, the fact represents that the memory is not connected or a failure in communication exists. When a mark X is added to the icons of the mobile phone and data base (DB), the fact represents the state where the digital camera 13 cannot communicate properly with the mobile phone and data base.

Accordingly, when the blue LED 40 flashes, it is possible to know either of the case where the memory card is not connected or the case where communication is failed by looking at the LCD display.

In this case, when all of the memory, mobile phone and data base cannot be used, the release section is locked so as not to carry out a releasing operation.

In the LCD, a mode switch 41 used for selecting image compressibility is disposed. By operating the mode switch 41, compressibility can be selected from three compress modes, i.e., (Hi) mode, (Md) mode and (Lw) mode. The (Hi) mode is used for an image that is seen in a small screen of the mobile phone, and only image data having extremely high compressibility are recorded under the (Hi) mode. Under the (Md) mode, stored are image data having extremely high compressibility similar to the one in the (Hi) mode, and image data being at the level in which compressibility is low so that no problem occurs when the image data are enlarged. The image data having extremely high compressibility are one that do not make the amount of communication large in an operation of downloading the image data from the data base after photographing and displaying the downloaded image data in the mobile phone. Under the (Lw) mode, image data having extremely high compressibility similar to one in the (Hi) mode and non-compressed data are stored.

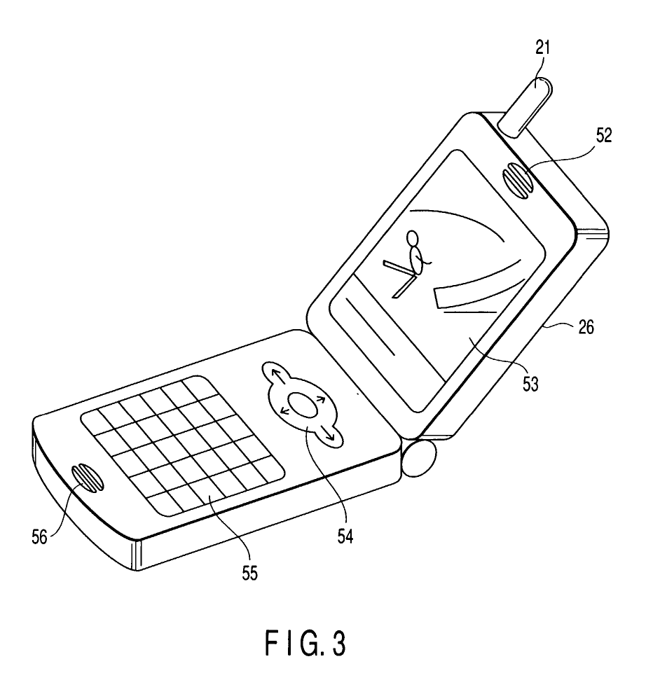

Next, the appearance of a mobile phone used in an embodiment of the invention will be described in detail with reference to FIG. 3. The mobile phone 26 includes a microphone 56, a loudspeaker 52, an antenna 21, an LCD (Liquid crystal digital) display section 53, key matrix 55 used for inputting telephone numbers or homepage addresses, and a vertical and lateral setting key 54. A position of a cursor in the display section 53 can be moved with use of the vertical and lateral setting key 54. Further, a sentence is input with use of the vertical and lateral setting key 54 together with the key matrix 55.

Incidentally, in FIG. 3, the embodiment of the mobile phone of double folding type has been described, however, a mobile phone having a straight shape may be used. In this case, a mobile phone is not particularly limited by its shape, a layout of keys or the like.

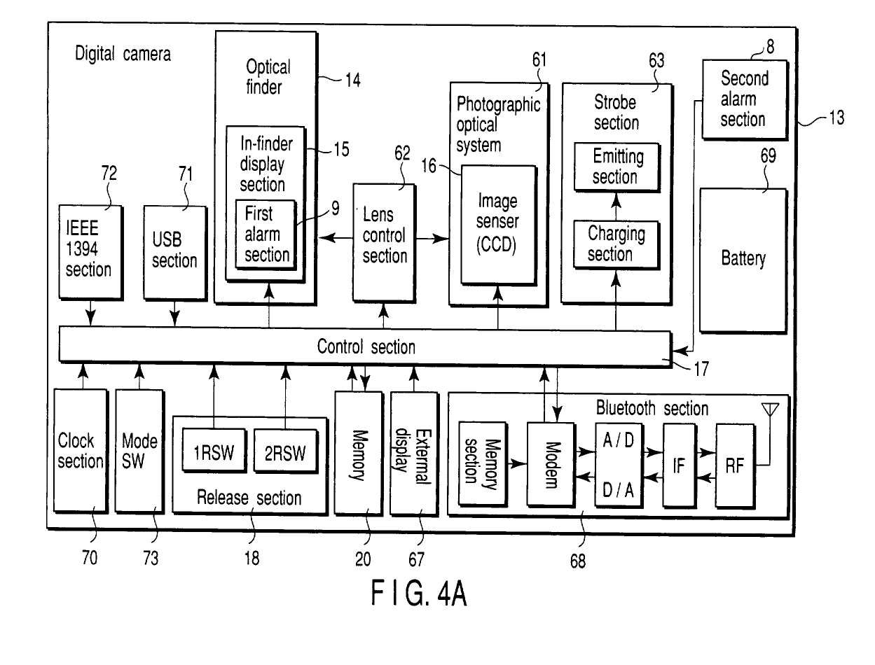

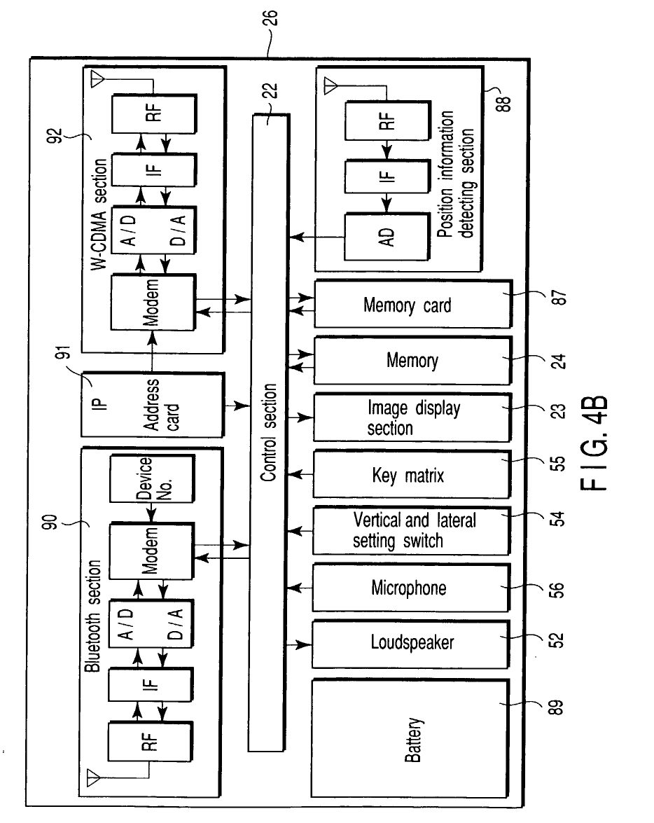

Next, an internal structure of a digital camera and mobile phone, both used in an embodiment according to the invention will be described in detail with reference to FIGS. 4A and 4B. As shown in FIG. 4A, the digital camera 13 has the optical finder 14 that includes the in-finder display section 15. The in-finder display section 15 is connected to the control section 17 that performs the entire control of the camera. The in-finder display section 15 includes the first alarm section 9 capable of giving various alarms. Further, the digital camera 13 has a photographic optical system 61 that includes the CCD image sensor 16, which is controlled by a lens control section 62 in an interlocked manner therewith. The digital camera 13 has a strobe section 63 that includes a charging section and emitting section, wherein light emission is carried out in the case where strobe emission is required in photographing.

The digital camera 13 has a release section 18. The release section 18 is operated with two-stage operations. The two-stage operations are constituted by a 1RSW (switch) as the first stage and a 2RSW as the second stage. At first, ranging, photometry and communication are started with the 1RSW, and then photographing is carried out with the 2RSW. The digital camera 13 has the memory 20 having relatively small capacity in which several-ten images can be stored, and an external display 67 to display a photographing state of the camera. Displaying the photographed image data are performed in a display section of the mobile phone 26. Therefore, a display section built in the camera is not particularly necessary. A LCD that is relatively inexpensive may be adopted.

Further, the digital camera 13 has a Bluetooth (TM) section 68 used for short-range communication, which performs communication with the mobile phone 26. The Bluetooth (TM) section 68 is constituted by an apparatus number storing section, a modem, A/D and D/A circuit, an interface (IF) section, an RF section and an antenna.

The digital camera 13 has a battery 69 to supply electric power to the entire electric circuit, a USB section 71 used for cable connection, and an IEEE1394 section 72. Thus, the digital camera 13 can be communicated to an external computer not shown. The digital camera 13 counts time in a clock section 70, and displays date on the external display 67. Further, the digital camera 13 also stores the time when photographing is performed in a memory 66 together with image data, and transmits the time to the mobile phone 26 or data base 10. Furthermore, a mode SW (switch) 73 that performs mode switching is provided in the digital camera 13. The digital camera further comprises a second alarm section 8 capable of giving various alarms.

As shown in FIG. 4B, in the mobile phone 26, there are provided the control section 22 that controls the entire control, the microphone 56 through which conversation is carried out, the loudspeaker 52, the key matrix 55 used for inputting characters or the like, a W-CDMA section 92 that is a radio communication circuit for the mobile phone, a detachable IP address card 91, and the position information detecting section 88. The W-CDMA section 92 is constituted by the modem, the A/D and D/A circuit, the interface (IF) section, the RF section and the antenna.

A user of the mobile phone can be specified through the IP address card 91 with use of an IF address. Information from the IP address card 91 is entered into the W-CDMA section 92, which is constituted by the modem, the A/D and D/A circuit, the interface (IF) section, the RF section and the antenna, thereby carrying out communication. Further, the mobile phone 26 has the vertical and lateral setting switch 54, the image display section 23, the memory 24, a detachable memory card 87, and battery section 89 to supply electric power source.

In the mobile phone 26, a Bluetooth (TM) section 90 that is a circuit equivalent to the Bluetooth (TM) section 68 is provided. Communication is carried out in accordance with a digital camera and standard specifications of the Bluetooth (TM), which is global standard specifications and thus has high reliability. Further, in order to detect position information on the photographed place, for example, the position information detecting section 88 constituted by a GPS (Global Positioning System) is disposed in the mobile phone 26. The position information detecting section 88 is constituted by the RF circuit, the IF section and an A/D section. Assuming that the position information detecting section 88 is the one using the GPS, the position information detecting section 88 detects radio waves supplied from three or more artificial satellites so as to detect accurate longitude and latitude. When photographed image data are stored in the data base, the position information can be stored together with the data. In addition, as another type of position information detecting section 88, a method may be employed such that three or more base stations of a mobile phone, which are located close to the mobile phone, are detected, and position information is detected based on the relative position from the stations. Further, the second alarm section 8 included in the digital camera 13 is configured to give an alarm when the mobile phone cannot access the data base, and thus the communication state between the mobile phone and the data base can be grasped on the side of the digital camera 13.

Next, a protocol structure according to an embodiment of the invention will be described in detail with reference to FIG. 5. Noted that, in regard to communication of the digital camera, only communication protocol stack of the Bluetooth (TM) relating to the invention will be shown. However, communication protocols of the USB, the IEEE1394 or the like connected by wire may be used.

In a protocol stack corresponding to the Bluetooth (TM) of a digital camera, the connection to a LSI or a module is secured with use of a physical layer constituted by a RF 100, a base band 101 and a Link Manager 102. Further, the connection in the protocol stack is secured with use of a middle ware constituted by a USB 103, an L2CAP (Logical Link Control Application Protocol) 104, an RFCOMM 105, an OBEX (Object Exchange Protocol) 106. Then, with use of an application layer which is constituted by a File Transfer 107 and an application program 108, instructions to process or transfer image data photographed and information on this image data, are performed.

In regard to the protocol stack of the mobile phone, there are many protocol stacks in addition to the protocol stack corresponding to the Bluetooth (TM) similar to one in the digital camera. The connection in the protocol stack is secured with use of a middle ware constituted by an audio section 112 used for a sound processing, an RS-232C110 for serial communication other than the USB and a PCMCIA111. Further, a TCP/IP113 enabling connection to the Internet is disposed. The application layer is constituted by a protocol stack concerning homepages and a user interface. There is provided a HTML browser 116 above a simplified window manager 114 for the mobile phone and a Kana-Kanji conversion engine 115, and thus browsing homepages is carried out. Further, with use of a Java virtual machine 117 and a CSE module 118, an application 119 in the HTML base is activated, thereby performing an excellent and advanced processing at a GUI (Graphical User Interface).

The protocol stack of the mobile base station comprises a cable, a base band, the Link Manager and the RF in its physical layer. For the middle layer of the protocol stack of the mobile base station, the TCP/IP is disposed. Above the middle layer, an application is provided as an application layer of the protocol stack. In the protocol stack of the mobile base station, radio communication from the mobile phone is delivered to communication to the base stations or an internet network.

The data base on the Internet comprises the Link Manager and a cable in its physical layer. For the middle of the data base, the TCP/IP is provided. As the application layer of the data base, there are provided an HTTP, a window manager, a server application, an HTML data base, and the user interface. The data base functions as a data base server by access from a high speed communication cable such as optical fiber or the like.

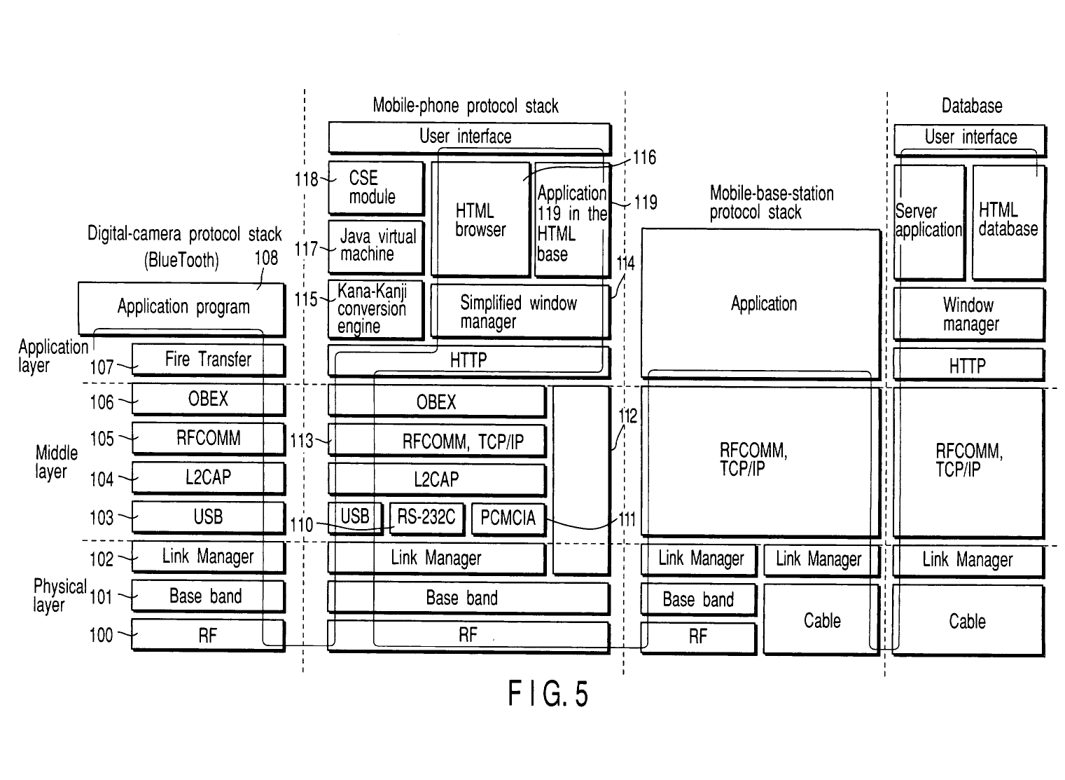

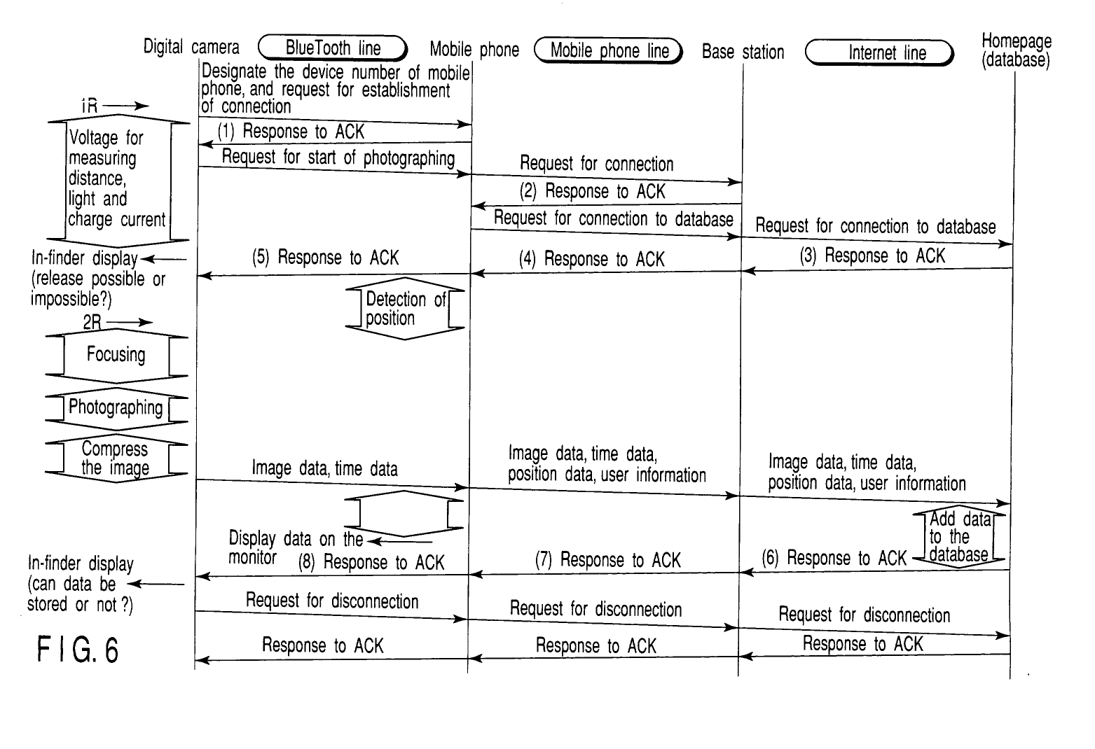

Next, mutual communication procedure between the digital camera, the mobile phone, the base station of the mobile phone and the data base will be described in detail with reference to FIG. 6. When the 1RSW of the digital camera is pressed, ranging, photometry and measurement of charging voltage are performed, and further the equipment number of the mobile phone as a communication partner is specified with use of the Bluetooth (TM) section so as to require establishing connection. Since the equipment number of the mobile phone is stored on the camera side in advance and the digital camera specifies the equipment with the equipment number, its own mobile phone can be specified without fail.

Subsequently, (1) when the digital camera receives an ACK response from the mobile phone, the connection between the digital camera and the mobile phone is established. Thereafter, requirement of starting to photograph is sent. The mobile phone requires connecting a circuit to the base station. (2) The circuit connection is confirmed with an ACK response from the base station. After that, the mobile phone sends requirement of connecting to the data base to the data base. (3) The base station receives an ACK response from the data base. (4) Subsequently, the base station sends an ACK response to the mobile phone. (5) Then, an ACK response is sent from the mobile phone to the digital camera so that it becomes clear whether the entire circuit from the digital camera to the data base is properly connected.

If the state is not normal, the abnormal state can be found by means of an NCK response notifying an abnormal state, or by the fact that communication cannot be carried out due to no response within a predetermined time period.

After the proper connection of the entire circuit from the digital camera to the data base, the blue LED among the various LEDs disposed in the digital camera is lit or flashed in accordance with the communication status. Further, the green LED is lit or flashed in accordance with the ranging result, and the orange LED is lit or flashed in accordance with necessity of charging voltage and emission. It is possible for a user of the digital camera to know whether or not the user can photograph by looking at these LEDs at the time of photographing, and thus the user can photograph reliably.

The mobile phone detects its position through the GPS or the like so that position information can be added to the photographed image data.

Subsequently, when the 2RSW is pressed, the digital camera brings an object into focus, and then photographs. After that, the digital camera compresses the photographed image data with the set compressibility and sends the compressed image data to the mobile phone together with photograph data such as photograph time or the like. The mobile phone displays an image based on the received highly compressed image data, and sends the received image data with the position information, user's information, etc. added to the data base. The data base adds the sent data to the data base. When the sent data is properly added to the data base, (6) an ACK response is sent back to the base station from the data base. (7) An ACK response is returned to the mobile phone from the base station. (8) An ACK response is returned to the digital camera from the mobile phone, and thus the fact that the data have been added properly to the data base is informed the digital camera. The blue LED within the finder of the digital camera is flashed twice after photographing so as to indicate that the data have been stored properly. After that, the circuit is cut (the digital camera transmits requirement of cutting the circuit to the data base, and then the data base returns an ACK response telling the completion of cutting to the digital camera.), a series of photographic sequence ends.

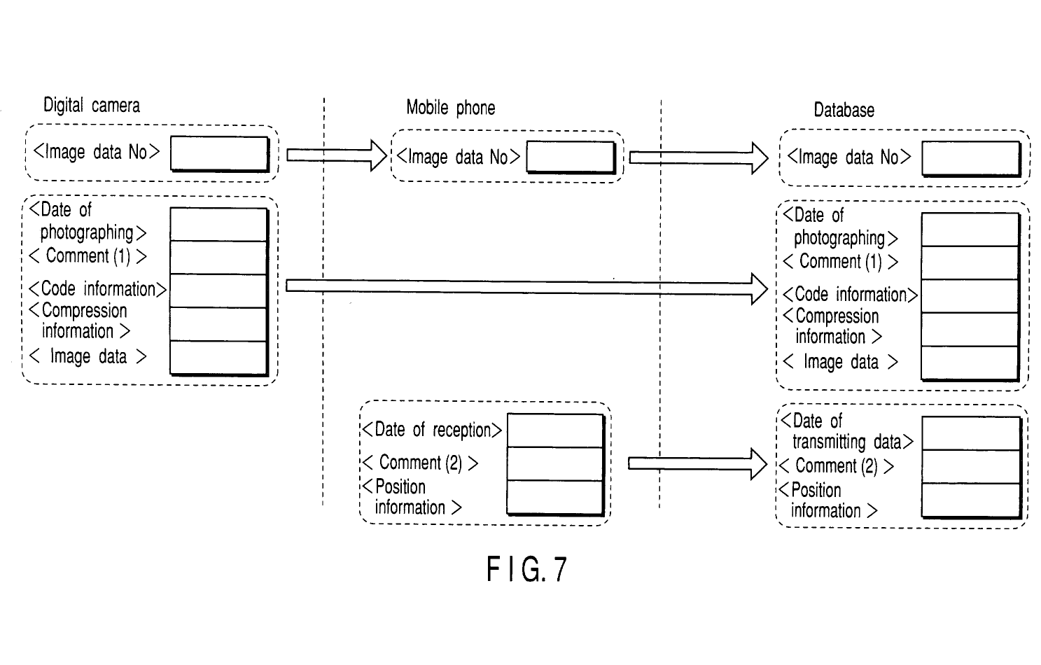

Next, a flow from a process that various data are added to the image data photographed in the digital camera to a process that the image data with various data added are stored in the data base will be described in detail with reference to FIG. 7. In a digital camera according to an embodiment of the invention, there are generated image number (No) data, photographed date and time data, comment data (1), code information, compression information, and image data. In a mobile phone, there are generated image number data, received date and time data, comment data (2), and position information. Both the data generated in the digital camera and the data generated in the mobile phone are related to each other, the image number data, photographed date and time data, the comment data (1) and (2), the code information, the compression information, the image data, transferred date and time data, and the position information are stored in a data base.

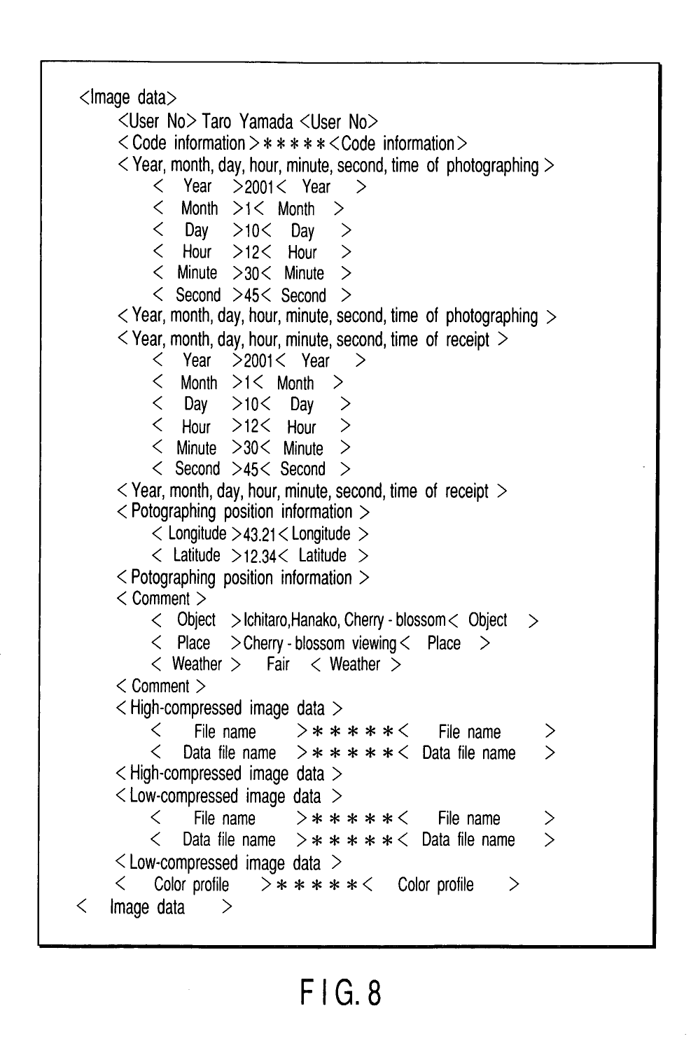

Next, data to be stored in a data base will be described in detail with reference to FIG. 8. In a data base according to an embodiment of the invention, the related various information mentioned above is stored for the respective photographed image data. The information is stored in a XML format. Accordingly, (1) XML information, (2) a high-compressed image data file and (3) a low-compressed image data file are related to one image.

The information in the XML information is described with use of tags in accordance with the XML format. At the position interposed between the tags of <User No>, a user's name is described; between the tags of <photographed year>, the year of photographing; between the tags of <photographed month>, the month of photographing; between the tags of <photographed date>, the date of photographing; between the tags of <photographed hour>, the hour of photographing; between the tags of <photographed minute>, the minute of photographing; and between the tags of <photographed second>, the second of photographing. As photographed position information, between the tags of <longitude>, the longitude in the position information is described; and between the tags of <latitude>, the latitude in the position information is described. When a comment is described, at the position interposed between the tags of <object>, the comment about the object is described; between the tags of <where the place>, the comment about the place where the object was photographed; and between the tags of <weather>, the comment about the weather of the time when the object was photographed. In regard to the tag of <high-compression image information>, at the position interposed between the tags of <compression information file name>, the compression information file name is described; and between the tags of <compressed image data file name>, the compressed image data file name is described. In regard to <low-compression image information>, the same manner as the description for the <high-compression image information> is employed. Information about color profiles, which is used for reproducing photographed images in accurate color, is described at the position interposed between the tags of <color profile>. In addition, a file about position information, a file of information about the world time and the like are stored.

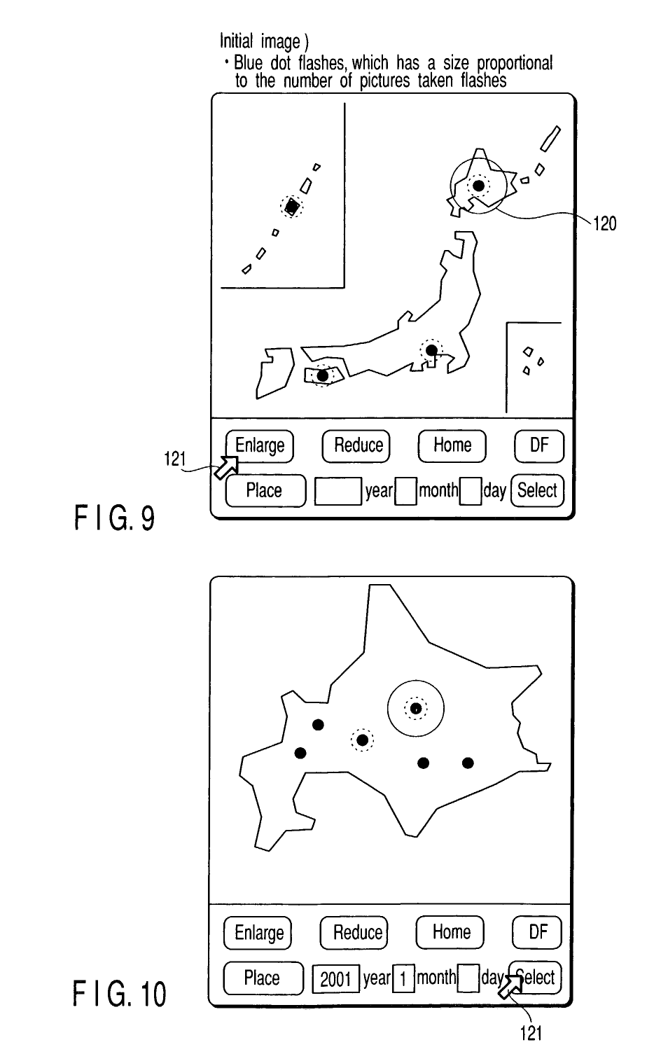

Next, a procedure for downloading a photographed image from a homepage of a data base through a mobile phone after photographing will be described in detail with reference to FIGS. 9, 10, 11 and 12. FIG. 9 shows an initial screen that is displayed on an LCD of a digital camera. On the LCD of the digital camera, a map of Japan is displayed. In the map of Japan, there are located blue circles, each having its own size which is proportional to the number of photographing in the image data photographed by means of the digital camera. On the LCD, a round cursor 120 is also located. At the lower portion of the LCD display, various buttons and input spaces are provided. An arrow cursor 121 is moved to the positions of the round cursor 120 or buttons by means of a vertical and lateral setting switch of the mobile phone, and then a setting switch (a center switch of the vertical and lateral setting switch) is pressed so as to switch from lighting to flashing, vice versa. Flashing parts (Circles surrounded by break lines, in drawings) are active. When the round cursor 120 is flashing, the active circles can be switched by means of the vertical and lateral setting switch. At that time, inputting into input spaces of year, month and date can be carried out. By moving the arrow cursor 121 to a selecting button and pressing a setting (determination) switch of the mobile phone, an operation in accordance with the display can be carried out. In FIG. 9, after moving the round cursor 120 to Hokkaido and causing the cursor to flash, the arrow cursor 121 is moved to a enlarging button and the setting switch is pressed. Then, a map of Hokkaido shown with the round circle 120 is enlarged as shown in FIG. 10.

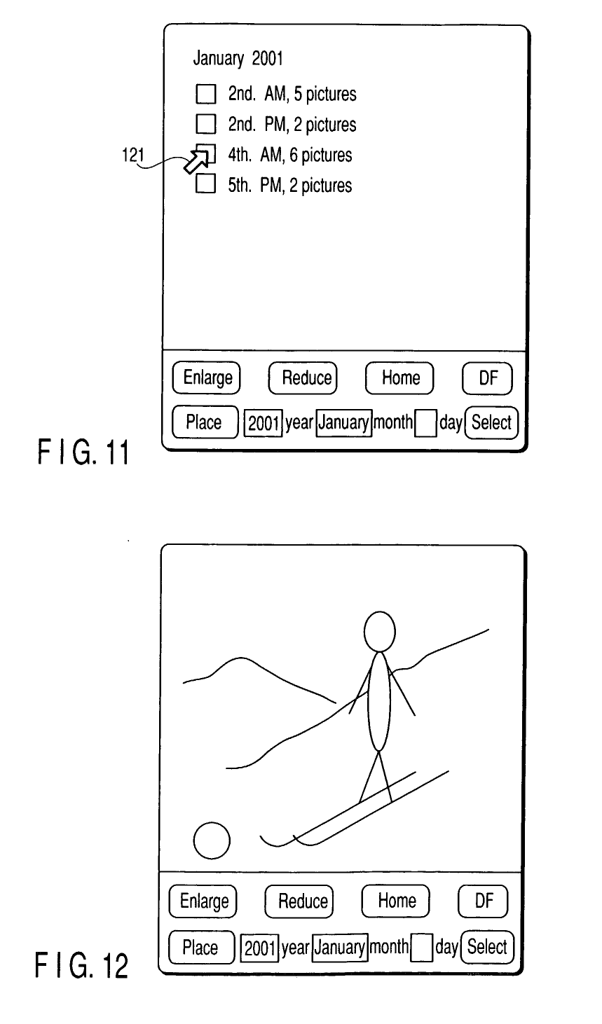

In FIG. 10, a blue circle having the size being proportional to the number of photographing is located in the same manner as one in the FIG. 9. For example, the input space of the year/month/date is input with “January 2001”, and the arrow cursor 121 is put on the selecting button. Then, the setting switch is pressed. As a result, the screen becomes one shown in FIG. 11. In FIG. 11, the number of images photographed in Hokkaido in January of 2001 is sorted with the date, AM (before noon) and PM (afternoon) and displayed. The arrow cursor 121 is moved to a square box on the left side of the date, and the setting switch is pressed. Then, for example, the first image is displayed among the six images in the morning of 4th (refer to FIG. 12). By pressing a lateral switch of the vertical and lateral setting switch, the six images photographed on 4th are displayed sequentially. In addition, by pressing a vertical switch, the date of photographing can be changed. Further, in FIG. 12, by moving the round cursor to an arbitrary position in the displayed image and pressing the enlarging button or reducing button, enlargement or reduction of the image can be carried out, respectively.

In each screen of FIGS. 9, 10, 11 and 12, the screen can be made a default screen by pressing a DF button. By pressing the DF button, the screen can be made the initial screen at the time when the homepage (data base) is accessed next time. Even if the number of photographed images is huge, the desired image can be displayed easily on the screen of the small mobile phone with use of the position information, and the date and time information. In the FIGS. 9, 10, 11 and 12, it is possible to access the data base so as to download the necessary information, as the need arises. Further, as shown in FIG. 6, each of the information is stored in the XML format that comprises the names of information items and contents. Thus the information can be retrieved easily in accordance with each of the information items. In addition, since the information is stored with the names of information items and their contents related to each other, increasing items to be retrieved can be dealt easily in a personal computer or a mobile terminal, each having a large screen.

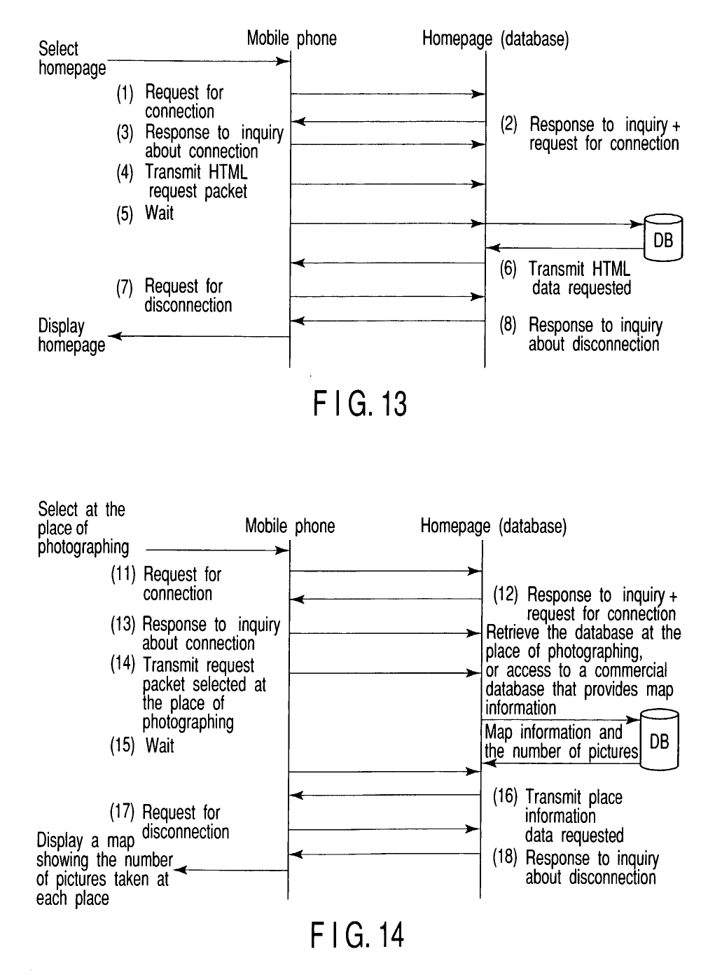

Next, a procedure for downloading an image will be described in detail with reference to FIGS. 13 to 18. A process of downloading the image is a communication procedure between a mobile phone and a data base (DB).

FIG. 13 is a diagram explaining a procedure for downloading an initial screen of the mobile phone from the data base. The mobile phone transmits requirement of establishing connection to the data base (1). The data base transmits a response of confirmation and the requirement of establishing connection to the mobile phone (2). The mobile phone transmits a response of confirming the connection to the data base (3), thereby establishing the connection with the data base. After that, the mobile phone transmits an HTML request packet to the data base (4). Subsequently, the mobile phone transmits a waiting signal and waits (5). The data base retrieves its own data base in accordance with conditions of setting default. Then, the HTML including the retrieved result is transmitted from the data base (6). The mobile phone downloads the HTML data including the retrieved result from the data base. Finally, the mobile phone transmits requirement of cutting the connection to the data base (7). The data base returns a response of requirement of cutting the connection to the mobile phone (8). Accordingly, for example, the data shown in FIG. 9 are downloaded to the mobile phone. Further, a map of Japan on which blue circles indicating the number of photographing are laid is displayed in the mobile phone.

FIG. 14 is a diagram explaining a procedure for setting the screen shown in FIG. 10. The mobile phone transmits requirement of establishing connection to the data base (11). The data base transmits a response of confirmation and the requirement of establishing connection to the mobile phone (12). The mobile phone transmits a response of confirming the connection to the data base (13), thereby establishing the connection with the data base. After that, the mobile phone transmits the longitude and latitude of Hokkaido that is the selected photographed position to the data base (14). The mobile phone transmits a waiting signal and waits (15). The data base retrieves its own data base in accordance with a condition of the photographed position, and calls map information and information on the number of photographing on a homepage of the data base. The data base transmits the photographed position data in accordance with the request to the mobile phone (16). At last, the mobile phone transmits requirement of cutting the connection to the data base (17). The data base returns a response of requirement of cutting the connection to the mobile phone (18). Accordingly, on the LCD of the mobile phone, a map on which the number of photographing for each photographed position can be displayed.

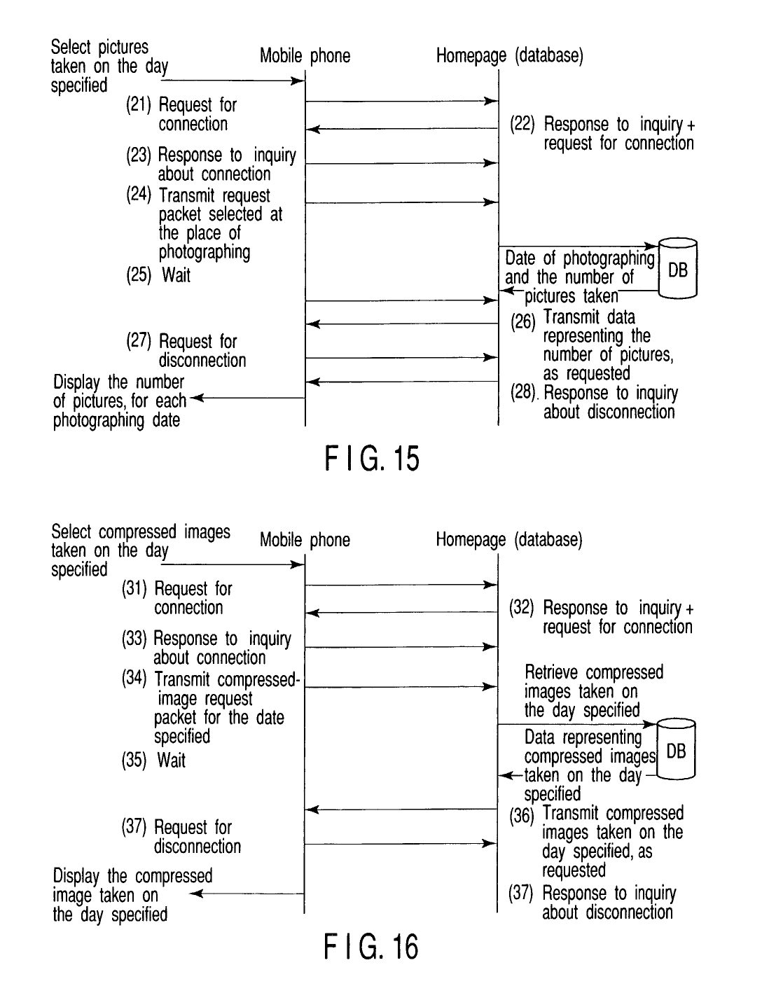

FIG. 15 is a diagram explaining a procedure for setting in the screen shown in FIG. 11. Focusing retrieval is performed with the photographed date. The mobile phone transmits requirement of establishing connection to the data base (21). The data base transmits a response of confirmation and the requirement of establishing connection to the mobile phone (22). The mobile phone transmits a response of confirming the connection to the data base (23), thereby establishing the connection with the data base. After that, the mobile phone transmits a photographed year and month request packet to the data base (24). The mobile phone transmits a waiting signal and waits (25). The data base retrieves its own data base in accordance with a condition of the photographed year and month, and calls information on the date and the number of photographing on a homepage of the data base. The data base transmits the information on the number of photographing in accordance with the request to the mobile phone (26). At last, the mobile phone transmits requirement of cutting the connection to the data base (27). The data base returns a response of requirement of cutting the connection to the mobile phone (28). Accordingly, on the LCD of the mobile phone, a map on which the number of photographing for each date can be displayed.

FIG. 16 is a diagram explaining a procedure for setting in the screen shown in FIG. 11. Focusing retrieval is performed with the photographed date of compressed image data. The mobile phone transmits requirement of establishing connection to the data base (31). The data base transmits a response of confirmation and the requirement of establishing connection to the mobile phone (32). The mobile phone transmits a response of confirming the connection to the data base (33), thereby establishing the connection with the data base. After that, the mobile phone transmits a photographed date request packet of the compressed image data to the data base (34). The mobile phone transmits a waiting signal and waits (35). The data base retrieves its own data base in accordance with a condition of the photographed year and month of the compressed image data, and calls information on the date and the number of photographing of the compressed image data on a homepage of the data base. The data base transmits the information on the number of photographing in accordance with the request to the mobile phone (36). At last, the mobile phone transmits requirement of cutting the connection to the data base (37). The data base returns a response of requirement of cutting the connection to the mobile phone (38). Accordingly, on the LCD of the mobile phone, a map on which the number of photographing for each date of the compressed image data can be displayed.

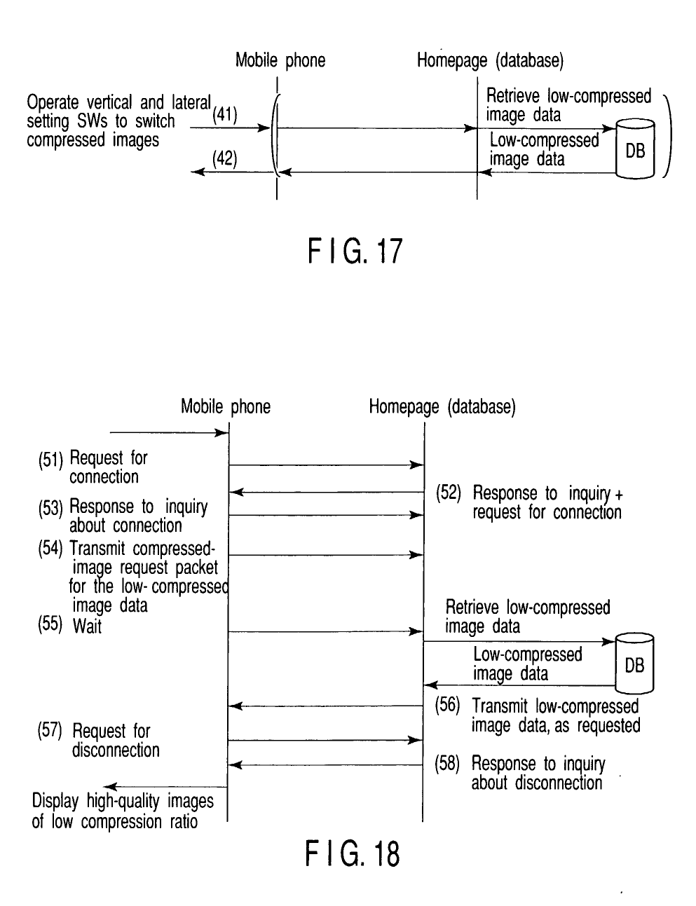

Next, a processing of switching image data will be described with reference to FIG. 17. When the processing of switching the image data displayed on the LCD of the mobile phone, a vertical and lateral SW (switch) of the mobile phone is used. For example, by pressing an upper switch of the vertical and lateral switch, a request to retrieve low-compressed image data is transmitted from the mobile phone to the data base (41). The data base transmits the image data in accordance with the request to the mobile phone (42). Accordingly, the image data are displayed on the LCD of the mobile phone. Further, if there is a margin in a memory of the mobile phone, the image data before switching are not canceled so as to keep being stored. By doing so, it becomes unnecessary to download again the image data that have been displayed once, and thus that image can be displayed promptly.

Next, a processing of enlarging image data displayed on the LCD of the mobile phone will be described with reference to FIG. 18. The mobile phone transmits requirement of establishing connection to the data base (51). The data base transmits a response of confirmation and the requirement of establishing connection to the mobile phone (52). The mobile phone transmits a response of confirming the connection to the data base (53), thereby establishing the connection with the data base. After that, the mobile phone transmits a request packet of the low-compressed image data to the data base (54). The mobile phone transmits a waiting signal and waits (55). The data base retrieves the image data in accordance with the request packet of the low-compressed image data, and transmits the retrieved image data to the mobile phone (56). At last, the mobile phone transmits requirement of cutting the connection to the data base (57). The data base returns a response of requirement of cutting the connection to the mobile phone (58).

When the request to enlarge the image data from the mobile phone can managed with data within the digital camera, it is not necessary to communicate with the data base. In addition, in the case where the image data are enlarged to a large extent and thus the image data are unsettled in a processing of enlarging, the low-compressed image data or non-compressed image data may be downloaded from the data base.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A digital camera comprising:
a release section to perform a shutter operation;
a finder section to observe an object;
a short-range radio communication section to perform radio communication with a radio communication terminal within a short range; and
a first alarm section to alarm in a case where radio communication with the radio communication terminal cannot be carried out with use of the short-range radio communication section, and
transmitting image data photographed in accordance with an operation of the release section with use of the short-range radio communication section.

2. The digital camera according to claim 1, wherein the finder section is an optical finder.

3. The digital camera according to claim 2, wherein the first alarm section is provided in an indicating section within the optical finder.

4. The digital camera according to claim 1, wherein the radio communication terminal, which is a mobile information terminal having an image display section, receives the image data transmitted from a digital camera and displays the photographed image data on the image display section.

5. The digital camera according to claim 3, wherein the radio communication terminal, which is a mobile information terminal having an image display section, receives the image data transmitted from a digital camera and displays the photographed image data on the image display section.

6. The digital camera according to claim 4, wherein the mobile information terminal has a mobile phone communication section, and with use of the mobile phone communication section, it is possible to access a data base on the Internet.

7. The digital camera according to claim 6, wherein, on receiving the image data from the digital camera, the mobile information terminal transmits the received image data to a data base on the Internet with use of the mobile phone communication section.

8. The digital camera according to claim 7, wherein the data base stores the image data transmitted from the mobile information terminal.

9. The digital camera according to claim 8, further comprising a second alarm section to alarm in a case where the mobile information terminal cannot access the data base.

10. The digital camera according to claim 9, wherein the second alarm section is an indicating section provided in a digital camera body.

11. The digital camera according to claim 1, further comprising a control section to forbid a photographing operation performed by the digital camera in a case where the first alarm section gives an alarm.

12. The digital camera according to claim 1, wherein the first alarm section is a LED.

13. The digital camera according to claim 12, wherein the LED lights in a case where radio communication can be carried out between the digital camera and the mobile information terminal, and between the digital camera and the data base.

14. The digital camera according to claim 12, wherein the LED flashes in a case where radio communication cannot be carried out between the digital camera and the mobile information terminal, or between the mobile information terminal and the data base.

15. The digital camera according to claim 1, wherein the release section can be pressed in a two-stage manner, ranging and photometry are performed by a press in a first stage, and a photographing operation is performed by a press in a second stage.

16. The digital camera according to claim 15, wherein the control section determines whether radio communication can be performed between the digital camera and the mobile information terminal by the press in the first stage.

17. A digital photographic system comprising:
a digital camera having a release section which performs a shutter operation, a first short-range radio communication section which performs radio communication and photographing image data in corresponding with an operation of the release section;
a radio communication terminal having a second short-range radio communication section which performs radio communication a mobile phone communication section which performs radio communication, a position information detecting section which detects a current position and an image displaying section which receives the image data transmitted from the digital camera and displays the received image data; and
a data base on the Internet, which receives the image data transmitted from the radio communication terminal and stores the received image data.

18. The digital photographic system according to claim 17, wherein the radio communication terminal relates image data transmitted from the digital camera to current position data detected by the position information detecting section, and transmits the related data to the data base.

19. The digital photographic system according to claim 18, wherein the data base receives the related image data, stores the received image data and uploads the stored image data to a homepage on the Internet.

20. The digital photographic system according to claim 19, wherein both the related image data and the current position data are displayed on the homepage in a manner that both data can be recognized visually.

21. An image transmission method using a digital photographic system which comprises a radio communication terminal having a radio communication section, a short-range radio communication section, a release section, a displaying section and a digital camera,
wherein the digital camera photographs an object in correspondence with an operation of the release section and generates image data concerning the object,
the digital camera transmits the image data to the radio communication terminal with use of the short-range radio communication section,
the radio communication terminal transmits the image data to a data base on the Internet with use of the radio communication section, and
the method using a digital photographic system which indicates a state of radio communication at the time of generating the image data or transmitting the image data in the indicating section.

22. The image transmission method using the digital photographic system according to claim 21, wherein the indicating section further has an alarm section, and the alarm section lights for indication in a case where the radio communication can be performed.

23. The image transmission method using the digital photographic system according to claim 22, wherein the alarm section flashes for indication in a case where the radio communication cannot be performed.

24. The image transmission method using the digital photographic system according to claim 21, wherein the indicating section is provided in the digital camera.
